(19) United States
(12) Patent Application Publication
(10) Pub. No.: US 2021/0053014 A1
(43) Pub. Date: Feb. 25, 2021

(54) MEMBRANE CLEANING DEVICE AND MEMBRANE CLEANING METHOD

(71) Applicant: Mitsubishi Electric Corporation, Chiyoda-ku (JP)

(72) Inventors: Yoshifumi HAYASHI, Chiyoda-ku (JP); Eiji IMAMURA, Chiyoda-ku (JP); Seiji NODA, Chiyoda-ku (JP)

(73) Assignee: Mitsubishi Electric Corporation, Chiyoda-ku (JP)

(21) Appl. No.: 17/046,899

(22) PCT Filed: May 30, 2018
(86) PCT No.: PCT/JP2018/020677

§ 371 Date: Oct. 12, 2020

(51) Int. Cl. B01D 65/02; C02F 1/66; C02F 1/78; C02F 1/44; C02F 3/12; C02F 1/00

(52) U.S. Cl. CPC B01D 65/02; C02F 1/66; C02F 1/78; C02F 1/44; C02F 3/1268; C02F 1/008; B01D 2321/168; C02F 2303/16; C02F 2209/23; C02F 2209/10; C02F 2209/06; B01D 2321/12; C02F 2201/782

(57) ABSTRACT

The membrane cleaning device uses treated water filtered through an MBR separation membrane as dissolution water, and performs a first process of dissolving ozone gas in the dissolution water under a neutral or alkaline condition, and a second process of dissolving ozone gas in the dissolution water under an acidic condition, to generate ozone water. At this time, whether to shift from the first process to the second process is determined on the basis of the organic substance concentration in the dissolution water, and whether to start feeding the ozone water to the separation membrane is determined on the basis of the dissolved ozone concentration in the dissolution water. Therefore, even when the organic substance concentration in the dissolution water varies depending on the MBR operation conditions, the treatment times in the first process and the second process can be optimized.

### TECHNICAL FIELD

The present disclosure relates to a membrane cleaning device and a membrane cleaning method for cleaning, with ozone water, a separation membrane for filtrating treatment target water.

### BACKGROUND ART

As a method for treating drained water (hereinafter, referred to as treatment target water) containing organic substances, there has been known a membrane bioreactor (hereinafter, referred to as MBR) in which organic substances in treatment target water are decomposed using activated sludge containing microorganisms and solid-liquid separation is performed through filtration using a separation membrane. As the separation membrane of the MBR continues to be used, contaminants adhere to the surface or the pores of the separation membrane and thus clogging occurs, whereby filtration performance gradually deteriorates. Therefore, for a membrane separation tank for performing filtration, a membrane cleaning device for cleaning the separation membrane with ozone water is provided together.

Conventionally, for the membrane cleaning device as described above, it is required that ozone water is efficiently generated to reduce the cost needed for generating ozone water, and technology therefor is being developed. For example, Patent Document 1 discloses, as a method for cleaning the separation membrane of the MBR, a method in which ozone gas is supplied to dissolution water in which an acid is added, thereby generating ozone water. Ozone water is self-decomposed under an alkaline condition, but is comparatively stable under an acidic condition. If the dissolution water is set at pH 5 or lower in advance, it is possible to generate ozone water using a less ozone supply amount.

Further, Patent Document 2 discloses a water treatment method in which, after an oxidation treatment step of performing an oxidation treatment on treatment target water by adding ozone to the treatment target water, the treatment target water having undergone the oxidation treatment is subjected to reverse osmosis membrane treatment, wherein the oxidation treatment step includes an alkaline oxidation treatment step of performing oxidation treatment under an alkaline condition and an acidic oxidation treatment step of performing oxidation treatment under an acidic to neutral condition. As in this conventional example, the alkaline oxidation treatment step is performed first, whereby efficiency of oxidation treatment for organic substances by ozone is enhanced, and organic substances in the dissolution water are decomposed so that the molecular weights thereof are reduced. By thereafter performing the acidic oxidation treatment step, it is possible to generate ozone water using a less ozone supply amount.

### CITATION LIST

### Patent Document

Patent Document 1: WO2016/031331

Patent Document 2: Japanese Laid-Open Patent Publication No. 2005-324118

### SUMMARY OF THE INVENTION

### Problems to be Solved by the Invention

In the case of using MBR treatment water as dissolution water for dissolving ozone gas, organic substances contained in the MBR treatment water react with ozone, so that ozone is ineffectively consumed. Therefore, it is necessary to efficiently decompose organic substances in the dissolution water. Hydroxyl radicals generated by self-decomposition of ozone have greater oxidizing power than ozone and are highly reactive with organic substances. However, in a method of generating ozone water under an acidic condition, the generation amount of hydroxyl radicals is small.

Therefore, in the case of using MBR treatment water as dissolution water in the method disclosed in Patent Document 1, it takes an enormous amount of time to decompose organic substances in the dissolution water, and thus the treatment time until reaching a dissolved ozone concentration required for membrane cleaning is prolonged. On the other hand, in the method of generating ozone water under an alkaline condition as in Patent Document 2, self-decomposition of ozone is promoted and the generation amount of hydroxyl radicals can be increased. Thus, it is possible to efficiently decompose organic substances in the dissolution water.

However, in the case of using MBR treatment water as dissolution water, the organic substance concentration in the MBR treatment water varies depending on the operation status of the MBR, and thus the amount of ozone required for decomposing organic substances also varies. Therefore, in the case where ozone gas is supplied at a constant concentration and a constant flow rate to the dissolution water, the treatment time required for decomposing organic substances varies. In Patent Document 2, the treatment time is determined irrespective of the organic substance concentration in the dissolution water, and thus the treatment time is not optimized. That is, even when the organic substance concentration in the dissolution water is low, the treatment time cannot be shortened, so that a longer treatment time than necessary is taken.

The present disclosure has been made to solve the above problems, and an object of the present disclosure is to provide a membrane cleaning device and a membrane cleaning method capable of efficiently generating ozone water to be used for membrane cleaning, thereby reducing the cost needed for generating ozone water.

### Solutions to the Problems

A membrane cleaning device according to the present disclosure is a membrane cleaning device for cleaning, with ozone water, a separation membrane for filtering treatment target water, the membrane cleaning device including: an ozone water generation unit which stores created water filtered through the separation membrane as dissolution water, and dissolves ozone gas in the dissolution water, to generate ozone water; ozone gas supply means for supplying ozone gas to the ozone water generation unit; and pH adjustment means for adjusting pH of the dissolution water stored in the ozone water generation unit, on the basis of an organic substance concentration in the dissolution water.

A membrane cleaning method according to the present disclosure is a membrane cleaning method for cleaning, with ozone water, a separation membrane for filtering treatment target water, the membrane cleaning method including: an ozone water generation process of using treated water filtered through the separation membrane as dissolution water and dissolving ozone gas in the dissolution water, to generate ozone water, wherein the ozone water generation process includes a first process of dissolving ozone gas in the dissolution water under a neutral or alkaline condition, and a second process of dissolving ozone gas in the dissolution water under an acidic condition after the first process, and whether to shift from the first process to the second process is determined on the basis of an organic substance concentration in the dissolution water, and whether to start feeding the ozone water to the separation membrane is determined on the basis of a dissolved ozone concentration in the dissolution water.

### Effect of the Invention

The membrane cleaning device according to the present disclosure includes the pH adjustment means for adjusting the pH of the dissolution water on the basis of the organic substance concentration in the dissolution water. Thus, a treatment time needed for decomposing organic substances in the dissolution water is estimated from the measured value of the organic substance concentration, and during this period, ozone water is generated under a pH condition suitable for decomposition of organic substances, and thereafter, the pH can be adjusted so as to reach a pH condition suitable for increasing the dissolved ozone concentration. Therefore, irrespective of variation in the organic substance concentration in the dissolution water, ozone water can be efficiently generated, and the cost needed for generating ozone water can be reduced.

In the membrane cleaning method according to the present disclosure, whether to shift from the first process to the second process is determined on the basis of the organic substance concentration in the dissolution water, whereby the treatment time in the first process can be optimized without excess/deficiency, and when the organic substance concentration in the dissolution water is low, the treatment time in the first process can be shortened. In addition, whether to start feeding ozone water to the separation membrane is determined on the basis of the dissolved ozone concentration in the dissolution water, whereby the treatment time in the second process can be optimized without excess/deficiency. Therefore, irrespective of variation in the organic substance concentration in the dissolution water, ozone water can be efficiently generated, and the cost needed for generating ozone water can be reduced.

Objects, features, aspects, and effects of the present disclosure other than the above will become more apparent from the following detailed description with reference to the drawings.

### BRIEF DESCRIPTION OF THE DRAWINGS

FIG. 1 is a diagram showing the entire configuration of a membrane cleaning device according to embodiment 1.

FIG. 2 is a diagram showing the configuration of process shift determination means of the membrane cleaning device according to embodiment 1.

FIG. 3 is a diagram showing the configuration of pH adjustment means of the membrane cleaning device according to embodiment 1.

FIG. 4 is a diagram showing the configuration of feeding start determination means of the membrane cleaning device according to embodiment 1.

FIG. 5 is a diagram showing an example of a connection part between an ozone water feeding pipe and a filtered water pipe in the membrane cleaning device according to embodiment 1.

FIG. 6 is a diagram showing another example of the connection part between the ozone water feeding pipe and the filtered water pipe in the membrane cleaning device according to embodiment 1.

FIG. 7 is a flowchart illustrating a membrane cleaning start procedure in the membrane cleaning device according to embodiment 1.

FIG. 8 is a diagram showing the entire configuration of a membrane cleaning device according to embodiment 2.

FIG. 9 is a diagram showing the configuration of process shift determination means of the membrane cleaning device according to embodiment 2.

FIG. 10 is a flowchart illustrating a membrane cleaning start procedure in the membrane cleaning device according to embodiment 2.

FIG. 11 is a diagram showing the entire configuration of a membrane cleaning device according to embodiment 3.

FIG. 12 is a flowchart illustrating a membrane cleaning start procedure in the membrane cleaning device according to embodiment 3.

FIG. 13 is a hardware configuration diagram implementing a part of the function of the process shift determination means, the pH adjustment means, or the feeding start determination means in the membrane cleaning device according to embodiment 1.

### DESCRIPTION OF EMBODIMENTS

### Embodiment 1

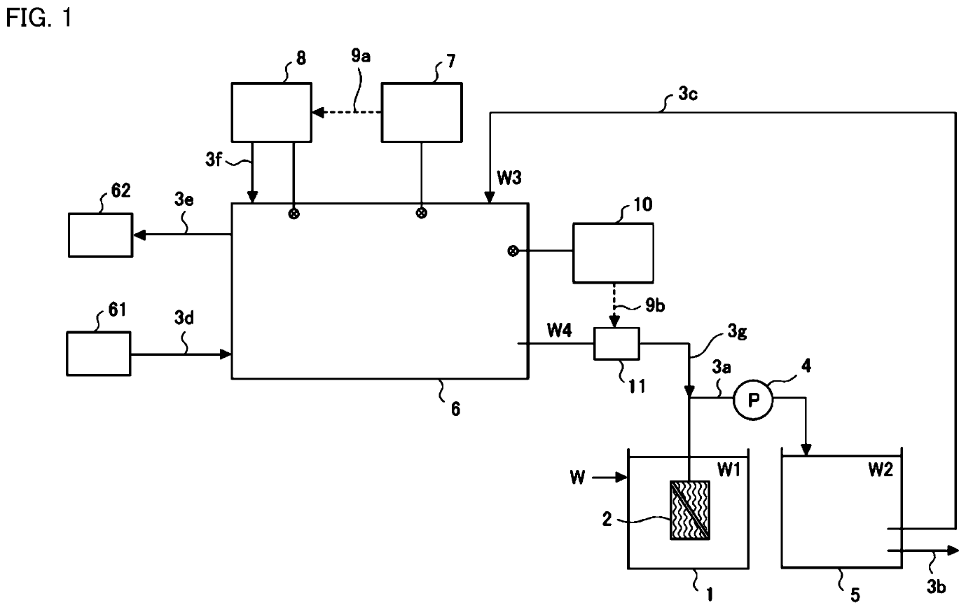

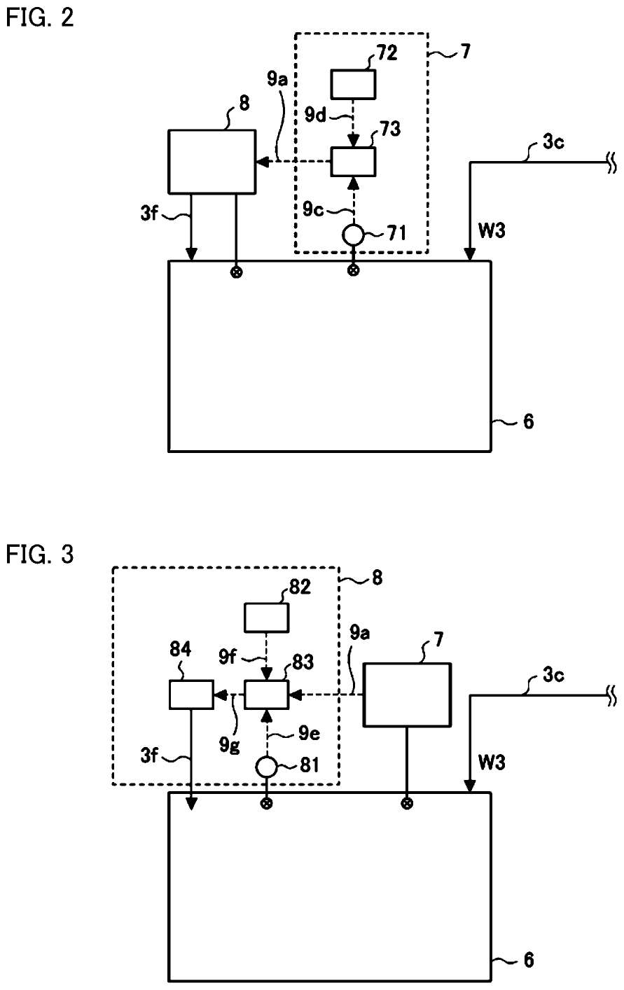

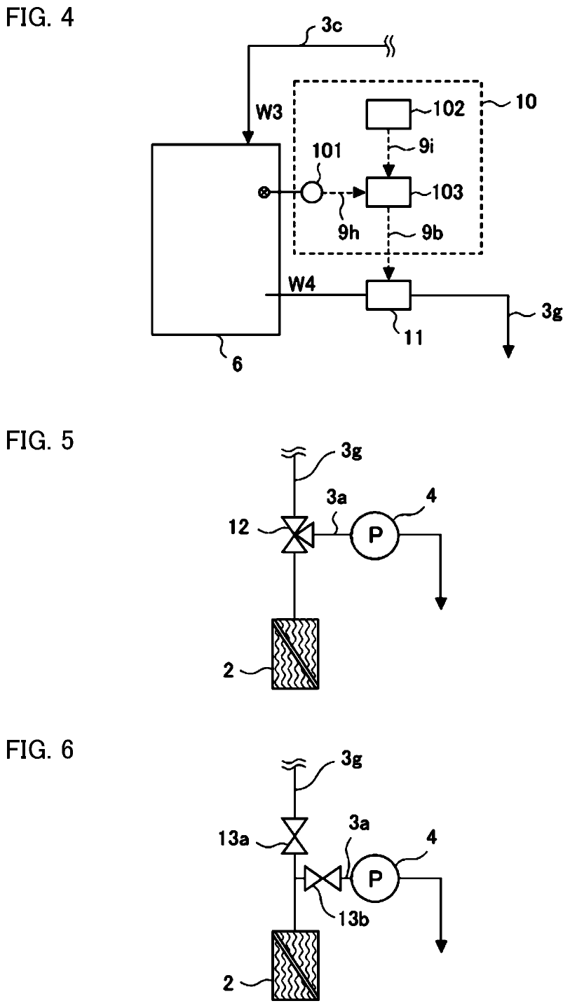

Hereinafter, a membrane cleaning device and a membrane cleaning method according to embodiment 1 of the present disclosure will be described with reference to the drawings. FIG. 1 shows the entire configuration of the membrane cleaning device according to embodiment 1. FIG. 2, FIG. 3, and FIG. 4 respectively show the configurations of process shift determination means, pH adjustment means, and feeding start determination means of the membrane cleaning device according to embodiment 1. In the drawings, the same or corresponding parts are denoted by the same reference characters.

The entire configuration of the membrane cleaning device according to embodiment 1 will be briefly described with reference to FIG. 1. The membrane cleaning device is for cleaning a separation membrane 2 which separates treatment target water W1 containing activated sludge into activated sludge and treated water W2, in a water treatment system using MBR, for example. In the following description, the membrane cleaning device for cleaning the separation membrane 2 of the MBR will be described. However, a membrane to be cleaned by the membrane cleaning device according to the present disclosure is not limited to the separation membrane 2 of the MBR, and activated sludge does not necessarily need to be contained in the treatment target water W1.

As shown in FIG. 1, a membrane separation tank 1 stores, as treatment target water W1, inflow water W which flows therein from an aeration tank (not shown) for performing organism treatment using activated sludge. The separation membrane 2 is provided in the membrane separation tank 1 and immersed in the treatment target water W1. The treatment target water W1 contains activated sludge, and is separated into activated sludge and treated water W2 through filtration by the separation membrane 2.

As the separation membrane 2 continues to be used, contaminants adhere to the surface or the pores thereof and thus clogging occurs. Therefore, it is necessary to clean the separation membrane 2 by the membrane cleaning device. The separation membrane 2 is connected to a filtered water pipe 3a and a filtration pump 4. Treated water W2 filtered through the separation membrane 2 is sucked by the filtration pump 4, to flow through the filtered water pipe 3a, and then is stored in a treated water tank 5.

The materials of the membrane separation tank 1 and the treated water tank 5 are not particularly limited, and may be made from concrete, stainless steel, or resin, for example. As the separation membrane 2, there are various types such as reverse osmosis membrane (RO membrane), nanofiltration membrane (NF membrane), ultra filtration membrane (UF membrane), and microfiltration membrane (MF membrane) which are different in pore size, and an appropriate one is selected from these. As the material of the separation membrane 2, a fluorine-based resin compound such as polytetrafluoroethyiene resin (PTFE) or polyvinylidene fluoride resin (PVDF) is highly resistant to ozone water and thus is preferable. It is noted that the separation membrane 2 may be a hollow fiber membrane or a flat membrane.

The treated water W2 stored in the treated water tank 5 is discharged to outside of the system through a treated water discharge pipe 3b, but partially flows through a dissolution water pipe 3c, to be stored as dissolution water W3 in an ozone water generation unit 6. The treated water discharge pipe 3b and the dissolution water pipe 3c may be each provided with one or both of a pump and a valve, as appropriate.

The ozone water generation unit 6 performs an ozone water generation process of using the treated water W2 as the dissolution water W3 and dissolving ozone gas in the dissolution water W3 to generate ozone water W4. The ozone water generation process includes a first process of dissolving ozone gas in the dissolution water W3 under a neutral or alkaline condition, and a second process of dissolving ozone gas in the dissolution water W3 under an acidic condition after the first process. The dissolution water W3 stored in the ozone water generation unit 6 increases in the dissolved ozone concentration through the ozone water generation process, to become ozone water W4 having a predetermined dissolved ozone concentration. In the following description, the dissolution water W3 that has reached the predetermined dissolved ozone concentration so that the dissolution water W3 can be used for membrane cleaning is referred to as “ozone water W4”.

As the material of the ozone water generation unit 6, for example, stainless steel or a fluorine-based resin compound is highly resistant to ozone and thus is preferable. The surface of the container of the ozone water generation unit 6 may be coated with a fluorine-based resin compound.

The ozone water generation unit 6 is connected via an ozone gas pipe 3d to an ozonizer 61 which is ozone gas supply means. The ozonizer 61 generates ozone gas using, as a raw material, for example, liquid oxygen or oxygen generated by pressure swing adsorption (PSA) or pressure vacuum swing adsorption (PVSA), and supplies the ozone gas to the ozone water generation unit 6. The ozone gas generated by the ozonizer 61 flows through the ozone gas pipe 3d to the ozone water generation unit 6. In the ozone water generation unit 6, ozone gas can be dissolved in the dissolution water W3 by a method such as ejector method, aeration method, or dissolution membrane method.

The ozone water generation unit 6 is connected to an exhaust ozone gas decomposition portion 62 via an exhaust ozone gas pipe 3e. In the exhaust ozone gas decomposition portion 62, a catalyst such as activated carbon or manganese oxide for decomposing ozone gas into oxygen is provided. The exhaust ozone gas discharged from the ozone water generation unit 6 is decomposed into oxygen through contact with the catalyst in the exhaust ozone gas decomposition portion 62, and then discharged to outside of the system.

The process shift determination means 7 determines whether to shift from the first process to the second process on the basis of the organic substance concentration in the dissolution water W3. The pH adjustment means 8 adjusts the pH of the dissolution water W3 stored in the ozone water generation unit 6 on the basis of the organic substance concentration in the dissolution water W3. The feeding start determination means 10 determines whether to start feeding ozone water to the separation membrane 2 on the basis of the dissolved ozone concentration in the dissolution water W3.

The ozone water feeding unit 11 is formed of an automatic valve of electromagnetic type or air type, a pump, and the like, and feeds the ozone water W4 generated by the ozone water generation unit 6 to the separation membrane 2, on the basis of a result of determination by the feeding start determination means 10. The ozone water W4 fed by the ozone water feeding unit 11 flows to the separation membrane 2 via an ozone water feeding pipe 3g and the filtered water pipe 3a, to clean the separation membrane 2. That is, the membrane cleaning using the ozone water W4 is reverse flow cleaning in which the ozone water W4 flews through the separation membrane 2 in a direction opposite to the direction in which the treatment target water W1 is filtered.

Next, functions of the process shift determination means 7 and the feeding start determination means 10 will be described. As described above, the ozone water generation process in the ozone water generation unit 6 includes the first process of dissolving ozone gas in the dissolution water W3 under a neutral or alkaline condition, and the second process of dissolving ozone gas in the dissolution water W3 under an acidic condition. The treatment time in the first process is determined by the process shift determination means 7, and the treatment time in the second process is determined by the feeding start determination means 10.

The self-decomposition speed of ozone becomes faster as the pH becomes higher, and hydroxyl radicals generated in the process of self-decomposition of ozone has higher oxidizing power than ozone. Therefore, in the first process of dissolving ozone gas in the dissolution water W3 under a neutral, or alkaline condition, efficiency of oxidation treatment on organic substances by the dissolved ozone is enhanced, whereby decomposition of organic substances in the dissolution water W3 can be promoted.

Preferably, the pH setting value in the first process is in a range from pH 7 to pH 10. If the pH is lower than 7, self-decomposition of ozone is inhibited and thus decomposition of organic substances cannot be promoted. If the pH is higher than 10, a large amount of an alkali to be added to the dissolution water W3 and a large amount of an acid to be added to the dissolution water W3 at the time of shifting to the second process are needed, and further, a large amount of ion components flows into the membrane separation tank 1 when membrane cleaning is performed, and thus influences treatment for the treatment target water W1. Therefore, setting the pH to higher than 10 is not preferable.

On the other hand, the self-decomposition speed of ozone is more inhibited as the pH is lowered. Therefore, in the second process of dissolving ozone gas in the dissolution water W3 under an acidic condition, self-decomposition of ozone Is inhibited as compared to the first process, whereby the dissolved ozone concentration can be increased. Preferably, the pH setting value in the second process is in a range from pH 2 to pH 6. In pH 2, the self-decomposition of ozone is inhibited almost perfectly. If the pH is lower than 2, a large amount of an acid to be added to the dissolution water W3 at the time of shifting to the second process is needed, and further, a large amount of ion components flows into the membrane separation tank 1 when membrane cleaning is performed, and thus influences treatment for the treatment target water W1. Therefore, setting the pH to lower than 2 is not preferable. In addition, if the pH is higher than 6, the dissolved ozone concentration decreases through self-decomposition of ozone. Therefore, setting the pH to higher than 6 is not preferable.

The organic substance concentration in the treated water W2 varies depending on the MBR operation conditions such as solid retention time (SRT) in the membrane separation device and the dissolved oxygen concentration in the treatment target water W1. Therefore, in the membrane cleaning device that uses the treated water W2 as the dissolution water W3, the amount of ozone gas needed for decomposing organic substances in the dissolution water W3 varies depending on the MBR operation conditions. In addition, in the case where a constant amount of ozone gas is supplied from the ozonizer 61 to the ozone water generation unit 6, the treatment time in the first process needed for decomposing organic substances in the dissolution water W3 varies depending on the MBR operation conditions. Therefore, the process shift determination means 7 estimates the treatment time in the first process needed for decomposing organic substances in the dissolution water W3, on the basis of the organic substance concentration in the dissolution water W3, to determine whether to shift to the second process, whereby the treatment time in the first process can be optimized without excess/deficiency.

In addition, the treatment time in the second process needed for generating the ozone water W4 having the predetermined dissolved ozone concentration also varies depending on variation in the composition and the concentration of dissolved components and the dissolved ozone concentration in the dissolution water W3 at the time of shifting to the second process. The predetermined dissolved ozone concentration is a dissolved ozone concentration that enables cleaning of contaminants adhered to the separation membrane 2, and specifically, is set in a range from 5 mg/L to 80 mg/L. Therefore, the feeding start determination means 10 determines whether to start feeding ozone water to the separation membrane 2, on the basis of the dissolved ozone concentration in the dissolution water W3, whereby the treatment time in the second process can be optimized without excess/deficiency.

Specific configurations of the process shift determination means 7, the pH adjustment means 8, and the feeding start determination means 10 according to embodiment 1 will be described with reference to FIG. 2, FIG. 3, and FIG. 4. As shown in FIG. 2, the process shift determination means 7 includes an organic substance sensor 71, a memory (second memory) 72, and a comparison unit (second comparison unit) 73. The organic substance sensor 71 and the comparison unit 73, the memory 72 and the comparison unit 73, and the comparison unit 73 and the pH adjustment means 8, are respectively connected via a signal line 9c, a signal line 9d, and a signal line 9a. The organic substance sensor 71 continuously or regularly measures the organic substance concentration in the dissolution water W3 stored in the ozone water generation unit 6, in the ozone water generation process (in particular, first process). The organic substance concentration can be measured using the absorbance for ultraviolet at 254 nm (UV254), total organic carbon (TOC), fluorescence intensity, or the like which is an index for organic substances.

The memory 72 stores a threshold for organic substance concentration for shifting from the first process to the second process. The comparison unit 73 acquires a measured value from the organic substance sensor 71 via the signal line 9c, and acquires the threshold stored in the memory 72 via the signal line 9d. Further, the comparison unit 73 compares the measured value from the organic substance sensor 71 with the threshold, and controls the pH adjustment means 8 so that the ozone water generation unit 6 shifts from the first process to the second process when the measured value becomes equal to or smaller than the threshold. Specifically, when the measured value from the organic substance sensor 71 becomes equal to or smaller than the threshold, the comparison unit 73 transmits a process shift signal to the pH adjustment means 8 via the signal line 9a.

The threshold for organic substance concentration can be calculated using the following Expression (1) in which an ozone water generation time including the first process and the second process is calculated using, as parameters, the organic substance concentration and a threshold for dissolved ozone concentration for starting cleaning. The organic substance concentration that minimizes the ozone water generation time calculated using Expression (1) can be used as the threshold for organic substance concentration for shifting from the first process to the second process.

[Ozone water generation time]=f(organic substance concentration, threshold for dissolved ozone concentration for starting cleaning) (1)

As shown in FIG. 3, the pH adjustment means 8 includes a pH sensor 81, a memory (fifth memory) 82, a pH adjustment control unit 83, and a pH adjustment unit 84. The pH sensor 81 and the pH adjustment control unit 83, the memory 82 and the pH adjustment control unit 83, the pH adjustment control unit 83 and the pH adjustment unit 84, and the pH adjustment control unit 83 and the process shift determination means 7, are respectively connected via signal lines 9e, 9f, 9g, 9a. The pH adjustment unit 84 and the ozone water generation unit 6 are connected to each other via an acid/alkali supply pipe 3f.

The pH sensor 81 continuously measures the pH of the dissolution water W3 stored in the ozone water generation unit 6, during the ozone water generation process. The memory 82 stores respective pH setting values for the dissolution water W3 for the first process and the second process. The pH adjustment control unit 83 controls the pH adjustment unit 84 so that the pH of the dissolution water W3 becomes the pH setting value stored in the memory 82 in the first process or the second process. The pH adjustment unit 84 stores an acid and an alkali, and supplies the acid or the alkali to the ozone water generation unit 6 on the basis of a signal transmitted via the signal line 9g from the pH adjustment control unit 83, to adjust the pH of the dissolution water W3.

Before the first process is started, the pH adjustment control unit 83 acquires a measured value from the pH sensor 81 via the signal line 9e, and acquires a pH setting value for the first process from the memory 82 via the signal line 9f. The pH adjustment control unit 83 transmits a signal to the pH adjustment unit 84 so as to add an acid if the measured value from the pH sensor 81 is higher than the pH setting value, and add an alkali if the measured value is lower than the pH setting value.

In addition, when the pH adjustment control unit 83 has received a process shift signal from the process shift determination means 7, the pH adjustment control unit 83 acquires the pH setting value for the second process from the memory 82, and transmits a signal to the pH adjustment unit 84 to perform control so that the pH of the dissolution water W3 becomes the pH setting value for the second process. It is noted that, since the process shift determination means 7 transmits a process shift signal on the basis of the organic substance concentration in the dissolution water W3, it can be said that the pH adjustment means 8 adjusts the pH of the dissolution water W3 on the basis of the organic substance concentration in the dissolution water W3 stored in the ozone water generation unit 6.

In shifting from the first process to the second process, the pH adjustment unit 84 adds an acid to the dissolution water W3 in the ozone water generation unit 6. It is noted that the acid/alkali supply pipe 3f may include a plurality of pipes, and may be provided with one or both of a pump and a valve as appropriate. The acid to be added to the dissolution water W3 is, for example, an aqueous solution of sulfuric acid, nitric acid, hydrochloric acid, or carbonic acid, or carbon dioxide gas, and the alkali is, for example, sodium hydroxide or sodium carbonate.

As shown in FIG. 4, the feeding start determination means 10 includes a dissolved ozone sensor 101, a memory (first memory) 102, and a comparison unit (first comparison unit) 103. The dissolved ozone sensor 101 and the comparison unit 103, the memory 102 and the comparison unit 103, and the comparison unit 103 and the ozone water feeding unit 11, are respectively connected via signal lines 9h, 9i, 9b.

The dissolved ozone sensor 101 measures the dissolved ozone concentration in the dissolution water W3 in the ozone water generation unit 6 during the ozone water generation process. For measurement of the dissolved ozone concentration, using ultraviolet absorbance allows continuous measurement to be easily performed, and thus is preferable. The memory 102 stores a threshold for dissolved ozone concentration for starting feeding ozone water to the separation membrane 2. Preferably, the threshold for dissolved ozone concentration is 5 mg/L to 80 mg/L.

The comparison unit 103 compares a measured value from the dissolved ozone sensor 101 with the threshold acquired from the memory 102 via the signal line 9i, and transmits a feeding start signal to the ozone water feeding unit 11 via the signal line 9b when the measured value becomes equal to or greater than the threshold. The ozone water feeding unit 11 feeds the ozone water W4 generated in the ozone water generation unit 6 to the separation membrane 2 via the ozone water feeding pipe 3g. Thus, cleaning of the separation membrane 2 by the membrane cleaning device is started.

As shown in FIG. 5 and FIG. 6, the ozone water feeding pipe 3g is connected to the filtered water pipe 3a. In an example shown in FIG. 5, the ozone water feeding pipe 3g, the filtered water pipe 3a, and the separation membrane 2 are connected via a three-way valve 12. In an example shown in FIG. 6, the ozone water feeding pipe 3g and the filtered water pipe 3a are respectively provided with switch valves 13a, 13b. The ozone water feeding pipe 3g may be provided with a pump as appropriate.

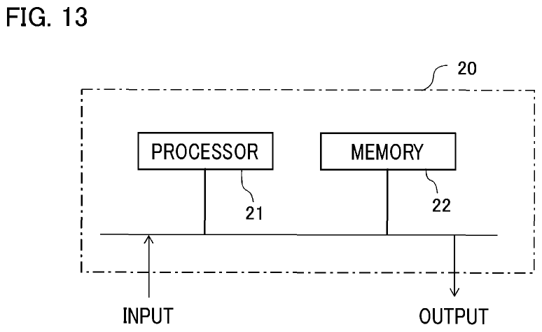

It is noted that, of the functions of the process shift determination means 7, the pH adjustment means 8, or the feeding start determination means 10, a function executed by software is implemented by a processing circuit 20 including a processor 21 and a memory 22 as shown in FIG. 13. For example, the function of the comparison unit 73 of the process shift, determination means 7, the pH adjustment control unit 83 of the pH adjustment means 8, or the comparison unit 103 of the feeding start determination means 10 is implemented by the processor 21 such as a CPU. The memory 22 includes a volatile storage device such as a random access memory, and a nonvolatile auxiliary storage device such as a flash memory. Instead of a flash memory, an auxiliary storage device of a hard disk may be provided. The processor 21 executes a program inputted from the memory 22. In this case, the program is inputted from the auxiliary storage device to the processor 21 via the volatile storage device.

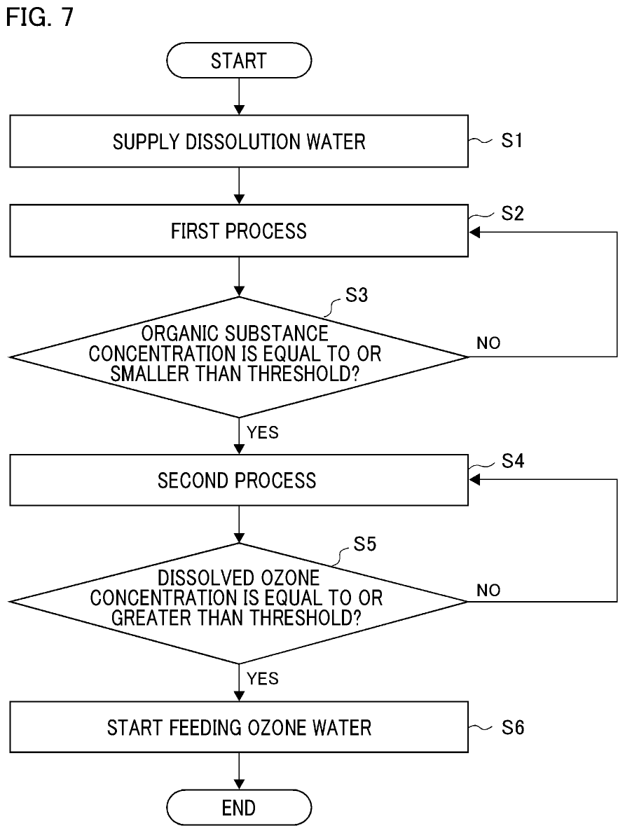

The procedure for starting membrane cleaning in the membrane cleaning device according to embodiment 1 will be described with reference to a flowchart shown in FIG. 7. First, in step S1, the dissolution water W3 is supplied to the ozone water generation unit 6. Specifically, the treated water W2 stored in the treated water tank 5 is fed to the ozone water generation unit 6 via the dissolution water pipe 3c, and is stored as the dissolution water W3.

Next, in step S2, the first process is performed. Specifically, the pH adjustment means 8 performs adjustment so that the pH of the dissolution water W3 stored in the ozone water generation unit 6 becomes the pH setting value for the first process stored in the memory 82 of the pH adjustment means 8. In addition, ozone gas generated by the ozonizer 61 is supplied to the ozone water generation unit 6 so that the ozone gas is dissolved in the dissolution water W3.

Subsequently, in step S3, whether or not the organic substance concentration in the dissolution water W3 in the ozone water generation unit 6 is equal to or smaller than the threshold, is determined. Specifically, the value of the organic substance concentration measured by the organic substance sensor 71 is compared with the threshold for organic substance concentration stored in the memory 72. In step S3, if the measured value of the organic substance concentration is greater than the threshold (NO), the process returns to step S2, to continue the first process. The pH setting value for the dissolution water W3 in the ozone water generation unit 6 is kept at the pH setting value for the first process.

In step S3, if the measured value of the organic substance concentration is equal to or smaller than the threshold (YES), the process proceeds to step S4, to perform the second process of the ozone water generation process. Specifically, the process shift determination means 7 transmits a process shift signal to the pH adjustment means 8 via the signal line 9a. When having received the process shift signal, the pH adjustment means 8 performs adjustment so that the dissolution water W3 becomes the pH setting value for the second process stored in the memory 82. At this time, supply of ozone gas is continued.

Next, in step S5, whether or not the dissolved ozone concentration in the dissolution water W3 is equal to or greater than the threshold, is determined. Specifically, the feeding start determination means 10 compares the value of the dissolved ozone concentration measured by the dissolved ozone sensor 101 with the threshold for dissolved ozone concentration stored in the memory 102. In step S5, if the measured value of the dissolved ozone concentration is smaller than the threshold (NO), the process returns to step S4, to continue the second process.

In step S5, if the measured value of the dissolved ozone concentration in the dissolution water W3 is equal to or greater than the threshold (YES), the process proceeds to step S6 and the ozone water feeding unit 11 starts feeding the ozone water W4. Specifically, the feeding start determination means 10 transmits a feeding start signal to the ozone water feeding unit 11 via the signal line 9b. When having received the feeding start signal, the ozone water feeding unit 11 feeds the ozone water W4 generated in the ozone water generation unit 6 to the separation membrane 2 via the ozone water feeding pipe 3g, to start cleaning of the separation membrane 2. During the cleaning, supply of ozone gas may be continued, or as long as the predetermined dissolved ozone concentration can be maintained, supply of ozone gas may be stepped.

As described above, according to embodiment 1, in the membrane cleaning device in which the treated water W2 filtered through the separation membrane 2 is used as the dissolution water W3 and ozone gas is dissolved in the dissolution water W3 to generate the ozone water W4, the pH of the dissolution water W3 stored in the ozone water generation unit 6 is adjusted on the basis of the organic substance concentration in the dissolution water W3. Therefore, even if the organic substance concentration varies depending on the MBR operation conditions, the treatment time needed for decomposing organic substances can be estimated from the measured value of the organic substance concentration. Therefore, during the treatment time needed for decomposing organic substances, ozone water can be generated under the pH condition suitable for decomposition of organic substances, and thereafter, the pH can be adjusted to reach the pH condition suitable for increasing the dissolved ozone concentration.

In addition, in the ozone water generation unit 6, the first process of dissolving ozone gas in dissolution water under a neutral or alkaline condition, and the second process of dissolving ozone gas in the dissolution water under an acidic condition, are performed, and whether to shift from the first process to the second process is determined on the basis of the organic substance concentration in the dissolution water W3. Therefore, the treatment time in the first process can be optimized without excess/deficiency, and when the organic substance concentration in the dissolution water W3 is low, the treatment time in the first process can be shortened.

In addition, whether to start feeding ozone water to the separation membrane 2 is determined on the basis of the dissolved ozone concentration in the dissolution water W3. Therefore, the treatment time in the second process can be optimized without excess/deficiency. Thus, according to embodiment 1, the ozone water W4 can be efficiently generated irrespective of variation in the organic substance concentration in the dissolution water W3 depending on the MBR operation conditions, whereby the cost needed for generating ozone water can be reduced.

### Embodiment 2

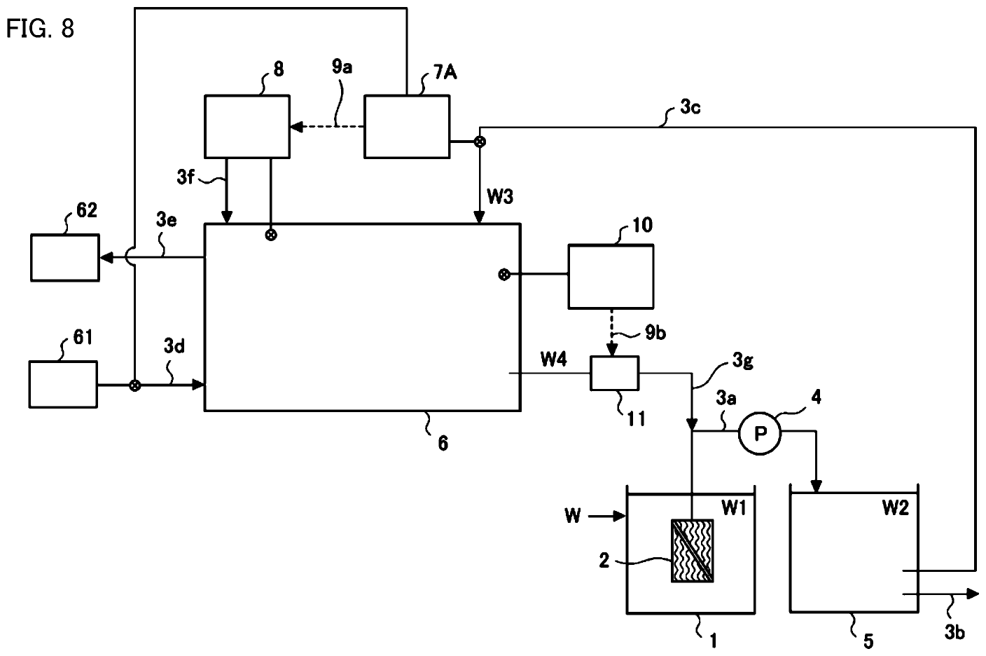

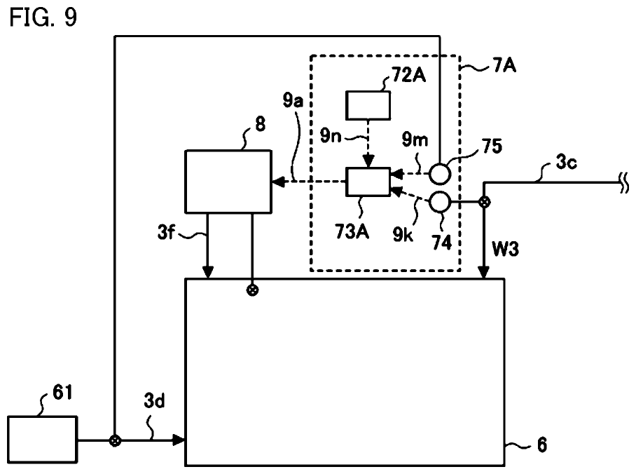

FIG. 8 shows the entire configuration of a membrane cleaning device according to embodiment 2 of the present disclosure, and FIG. 9 shows the configuration of process shift determination means of the membrane cleaning device according to embodiment 2. The membrane cleaning device according to embodiment 2 is different from the membrane cleaning device according to the above embodiment 1 only in the configuration of the process shift determination means. The other configurations are the same and therefore the description thereof is omitted here.

The membrane cleaning device according to embodiment 2 includes process shift determination means 7A. As shown in FIG. 9, the process shift determination means 7A includes an organic substance sensor 74, an ozone gas sensor 75, a memory (third memory) 72A, and a comparison unit (third comparison unit) 73A. The organic substance sensor 74 and the comparison unit 73A, the ozone gas sensor 75 and the comparison unit 73A, and the memory 72A and the comparison unit 73A, are respectively connected via signal lines 9k, 9m, 9n.

The organic substance sensor 74 measures an initial value of the organic substance concentration in the dissolution water W3 to be supplied to the ozone water generation unit 6, before start of the ozone water generation process. The organic substance sensor 74 is favorably provided at the dissolution water pipe 3c or the ozone water generation unit 6, but the provided position thereof is not particularly limited. Before start of the ozone water generation process, the dissolution water W3 may be sampled and the organic substance concentration thereof may be measured. The organic substance concentration can be measured using UV254, TOC, fluorescence intensity, or the like which is an index for organic substances.

The ozone gas sensor 75 is provided to the ozone gas pipe 3d and measures an ozone gas amount (hereinafter, referred to as ozone supply amount) supplied to the ozone water generation unit 6. The ozone supply amount is calculated from the cumulative value of the ozone gas concentration and the flow rate. The ozone supply amount needed until shifting from the first process to the second process differs depending on the initial value of the organic substance concentration in the dissolution water W3. That is, if the initial value of the organic substance concentration in the dissolution water W3 is great, the ozone supply amount needed until shifting from the first process to the second process is also increased.

The memory 72A stores a threshold for ozone supply amount needed until shifting from the first process to the second process, the threshold being set so as to correspond to the initial value of the organic substance concentration in the dissolution water W3. The comparison unit 73A acquires, from the memory 72A, the threshold for ozone supply amount corresponding to the organic substance concentration acquired from the organic substance sensor 74, and compares the measured value of the ozone supply amount acquired from the ozone gas sensor 75 with the threshold. When the measured value becomes equal to or greater than the threshold, the comparison unit 73A transmits a process shift signal to the pH adjustment means 8 via the signal line 9a.

The organic substances in the dissolution water W3 react with ozone and thus decrease. Therefore, the organic substance concentration in the dissolution water W3 during the ozone water generation process can be estimated using, as parameters, the initial value of the organic substance concentration in the dissolution water W3 and the ozone supply amount. The threshold for ozone supply amount can be calculated using the following Expression (2) in which the organic substance concentration in the dissolution water W3 is calculated using, as parameters, the initial value of the organic substance concentration in the dissolution water W3 and the ozone supply amount. The ozone supply amount when the organic substance concentration calculated using Expression (2) becomes the threshold for organic substance concentration calculated by an organic substance concentration threshold calculation method (e.g., Expression(1)), is calculated, and the calculated ozone supply amount is used as the threshold for ozone supply amount.

(Organic substance concentration)=f(initial value of organic substance concentration, ozone supply amount) (2)

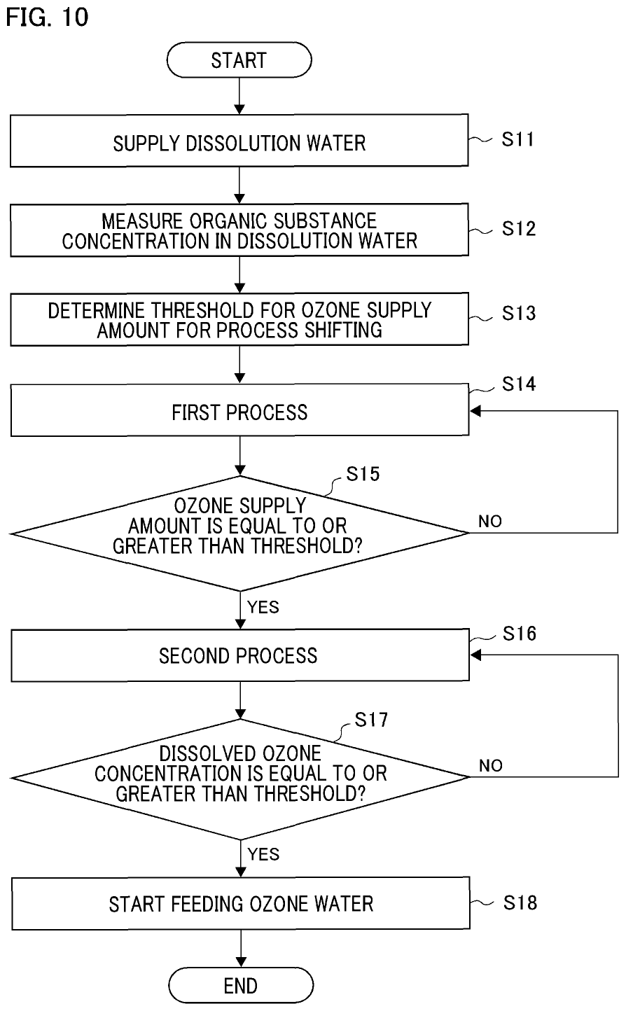

The membrane cleaning start procedure in the membrane cleaning device according to embodiment 2 will be described with reference to a flowchart shown in FIG. 10. It is noted that the description of the same procedure as in the flowchart shown in FIG. 7 in the above embodiment 1 will not be repeated. First, in step S11, the dissolution water W3 is supplied to the ozone water generation unit 6. Next, in step S12, the initial value of the organic substance concentration in the dissolution water W3 is measured by the organic substance sensor 74. Subsequently, in step S13, the threshold for ozone supply amount for process shifting is determined. Specifically, the comparison unit 73A of the process shift determination means 7A acquires, from the memory 72A, the threshold for ozone supply amount corresponding to the initial value of the organic substance concentration measured by the organic substance sensor 74.

Next, in step S14, the first process is performed. Subsequently, in step S15, whether or not the ozone supply amount supplied to the dissolution water W3 in the ozone water generation unit 6 is equal to or greater than the threshold, is determined. Specifically, the comparison unit 73A of the process shift determination means 7A compares the value of the ozone supply amount measured by the ozone gas sensor 75 with the threshold determined in step S13. In step S15, if the measured value of the ozone supply amount is smaller than the threshold (NO), the process returns to step 314, to continue the first process. In step S15, if the measured value of the ozone supply amount is equal to or greater than the threshold (YES), the process proceeds to step S16, to perform the second process. The subsequent process from step S16 is the same as the subsequent process from step S4 in the flowchart in FIG. 7.

In the membrane cleaning device according to embodiment 2, the threshold for ozone supply amount corresponding to the initial value of the organic substance concentration in the dissolution water W3 is determined, and when the measured value of the ozone supply amount becomes equal to or greater than the threshold, shift from the first process to the second process is performed. Thus, the same effects as in the above embodiment 1 are obtained.

### Embodiment 3

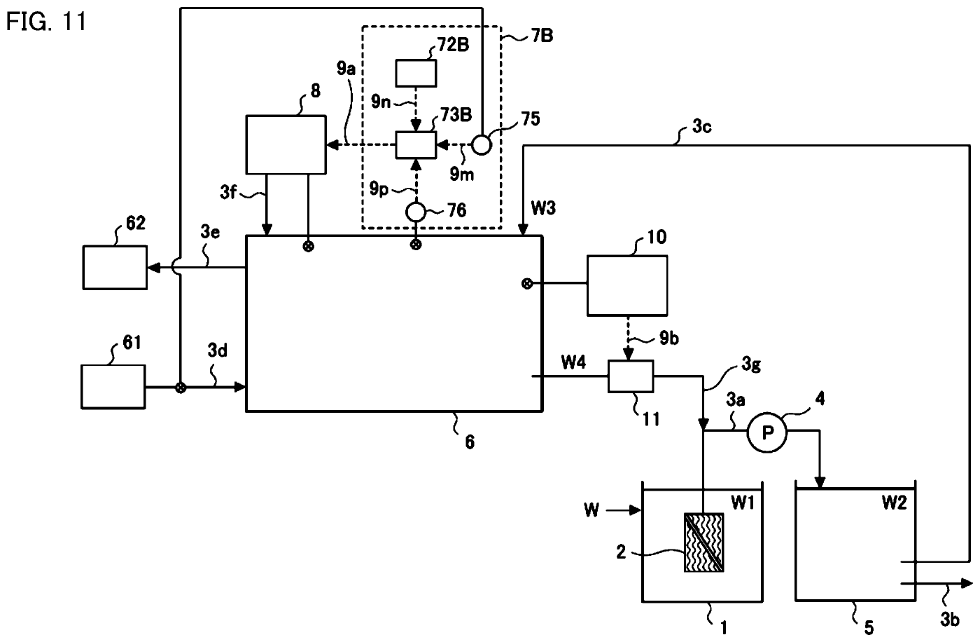

FIG. 11 shows the entire configuration of a membrane cleaning device according to embodiment 3 of the present disclosure. The membrane cleaning device according to embodiment 3 is different from the membrane cleaning device according to the above embodiment 1 only in the configuration of the process shift determination means. The other configurations are the same and therefore the description thereof is omitted here.

The membrane cleaning device according to embodiment 3 includes process shift determination means 7B. As shown in FIG. 11, the process shift determination means 7B Includes a dissolved ozone sensor 76, an ozone gas sensor 75, a memory (fourth memory) 72B, and a comparison unit (fourth comparison unit) 73B. The dissolved ozone sensor 76 and the comparison unit 73B, the ozone gas sensor 75 and the comparison unit 73B, the memory 72B and the comparison unit 73B, and the comparison unit 73B and the pH adjustment means 8, are respectively connected via signal lines 9p, 9m, 9n, 9a.

The dissolved ozone sensor 76 continuously measures the dissolved ozone concentration in the dissolution water W3 stored in the ozone water generation unit 6, during the ozone water generation process. It is noted that the dissolved ozone sensor 101 (see FIG. 4) of the feeding start determination means 10 may be shared as the dissolved ozone sensor 76 of the process shift determination means 7B. As in the above embodiment 2, the ozone gas sensor 75 is provided to the ozone gas pipe 3d and measures the ozone supply amount from the cumulative value of the ozone gas concentration and the flow rate.

The memory 72B stores a threshold for dissolved ozone concentration needed until shifting from the first process to the second process, the threshold being set so as to correspond to the ozone supply amount supplied to the dissolution water W3. The comparison unit 73B compares the measured value obtained by the dissolved ozone sensor 76 with the threshold stored in the memory 72B, and when the measured value of the dissolved ozone concentration becomes equal to or greater than the threshold, the comparison unit 73B transmits a process shift signal to the pH adjustment means 8 via the signal line 9a.

Ozone supplied to the dissolution water W3 is partially dissolved in the dissolution water W3 to become dissolved ozone, and reacts with organic substances in the dissolution water W3 and thus is consumed. Therefore, the organic substances in the dissolution water W3, dissolved ozone, and supplied ozone gas are in an equilibrium condition. For example, if the concentration of organic substances which consume ozone decreases, the dissolved ozone concentration increases. That is, the organic substance concentration in the dissolution water W3 can be estimated using the dissolved ozone concentration and the ozone supply amount as parameters. The comparison unit 73B of the process shift determination means 7B estimates the organic substance concentration in the dissolution water W3 using the dissolved ozone concentration in the dissolution water W3 and the ozone supply amount as parameters, and determines whether to shift from the first process to the second process, on the basis of the estimated organic substance concentration in the dissolution water W3.

The threshold for dissolved ozone concentration can be calculated using the following Expression (3) in which the organic substance concentration in the dissolution water W3 is calculated using the dissolved ozone concentration and the ozone supply amount as parameters. The dissolved ozone concentration when the organic substance concentration calculated using Expression (3) becomes the threshold for organic substance concentration calculated by an organic substance concentration threshold calculation method (e.g., Expression (1)), is calculated, and the calculated dissolved ozone concentration is used as the threshold for dissolved ozone concentration.

(Organic substance concentration)=f(dissolved ozone concentration, ozone supply amount) (3)

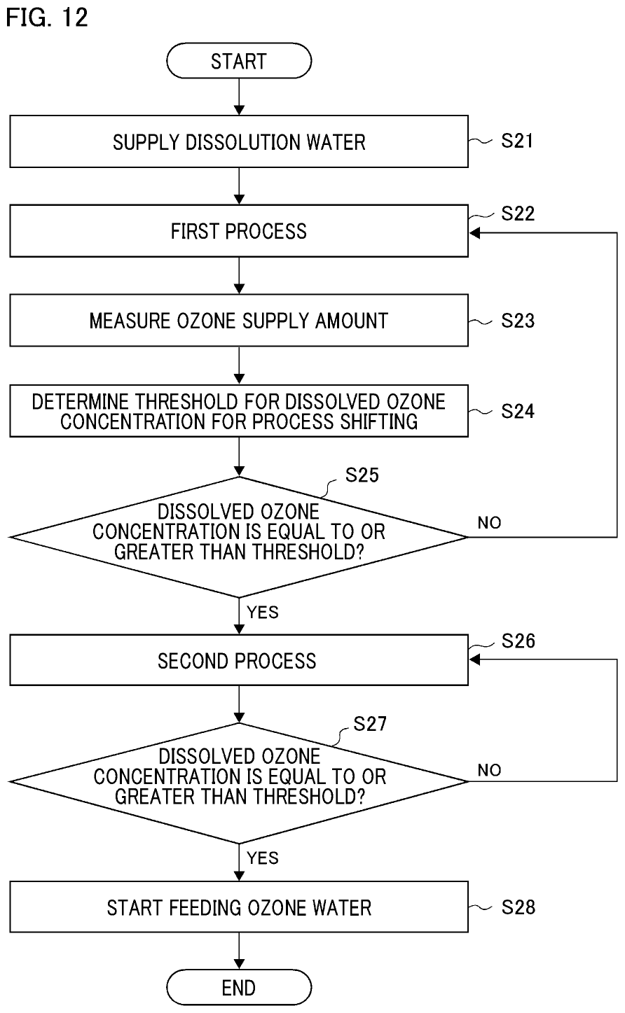

A membrane cleaning start procedure in the membrane cleaning device according to embodiment 3 will be described with reference to a flowchart shown in FIG. 12. It is noted that the description of the same procedure as in the flowchart shown in FIG. 7 in the above embodiment 1 will not be repeated. First, in step S21, the dissolution water W3 is supplied to the ozone water generation unit 6. Next, in step S22, the first process is performed, and subsequently, in step S23, the ozone supply amount is measured by the ozone gas sensor 75.

Next, in step S24, the threshold for dissolved ozone concentration for process shifting is determined. Specifically, the comparison unit 73B of the process shift determination means 7B acquires, from the memory 72B, the threshold for dissolved ozone concentration corresponding to the ozone supply amount measured by the ozone gas sensor 75. Subsequently, in step S25, whether or not the dissolved ozone concentration in the dissolution water W3 in the ozone water generation unit 6 is equal to or greater than the threshold, is determined. Specifically, the comparison unit 73B of the process shift determination means 7B compares the value of the dissolved ozone concentration measured by the dissolved ozone sensor 76 with the threshold determined in step S24.

In step S25, if the measured value of the dissolved ozone concentration is smaller than the threshold (NO), the process returns to step S22, to continue the first process. In step S25, if the measured value of the dissolved ozone concentration is equal to or greater than the threshold (YES), the process proceeds to step S26, to perform the second process. The subsequent process from step S26 is the same as the subsequent process from step S4 in the flowchart in FIG. 7.

In embodiment 3, the threshold for dissolved ozone concentration corresponding to the ozone supply amount supplied to the dissolution water W3 is determined, and when the measured value of the dissolved ozone concentration becomes equal to or greater than the threshold, shift from the first process to the second process is performed. Thus, the same effects as in the above embodiment 1 are obtained.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 membrane separation tank

2 separation membrane

3a filtered water pipe

3b treated water discharge pipe

3c dissolution water pipe

3d ozone gas pipe

3e exhaust ozone gas pipe

3f acid/alkali supply pipe

3g ozone water feeding pipe

4 filtration pump

5 treated water tank

6 ozone water generation unit

7, 7A, 7B process shift determination means

8 pH adjustment means

9a, 9b, 9c, 9d, 9e, 9f, 9g, 9h, 9i, 9k, 9m, 9n, 9p signal line

10 feeding start determination means

11 ozone water feeding unit

12 three-way valve

13a, 13b switch valve

20 processing circuit

21 processor

61 ozonizer

62 exhaust ozone gas decomposition portion

71, 74 organic substance sensor

22, 72, 72A, 72B, 82, 102 memory

73, 73A, 73B, 103 comparison unit

75 ozone gas sensor

76, 101 dissolved ozone sensor

81 pH sensor

83 pH adjustment control unit

84 pH adjustment unit

1. A membrane cleaning device for cleaning, with ozone water, a separation membrane for filtering treatment target water, the membrane cleaning device comprising:
an ozone water generation tank which stores treated water filtered through the separation membrane as dissolution water, and dissolves ozone gas in the dissolution water, to generate ozone water;
an ozonizer for supplying ozone gas to the ozone water generation tank; and
pH adjustment device for adjusting pH of the dissolution water stored in the ozone water generation tank, on the basis of an organic substance concentration in the dissolution water.

2. The membrane cleaning device according to claim 1, further comprising:
a feeding start determination device for determining whether to start feeding the ozone water from the ozone water generation tank to the separation membrane, on the basis of a dissolved ozone concentration in the dissolution water; and
an ozone water feeding device for feeding the ozone water generated in the ozone water generation tank to the separation membrane on the basis of a result of determination by the feeding start determination device.

3. The membrane cleaning device according to claim 2, wherein
the feeding start determination device includes
a dissolved ozone sensor to measure the dissolved ozone concentration in the dissolution water in the ozone water generation tank,
a first memory to store a threshold for the dissolved ozone concentration for starting feeding the ozone water, and
a first processor to compare a measured value by the dissolved ozone sensor with the threshold stored in the first memory, and to cause the ozone water feeding device to feed the ozone water when the measured value becomes equal to or greater than the threshold.

4. The membrane cleaning device according to claim 1, wherein
the ozone water generation tank performs a first process of dissolving ozone gas in the dissolution water under a neutral or alkaline condition, and a second process of dissolving ozone gas in the dissolution water under an acidic condition after the first process.

5. The membrane cleaning device according to claim 4, further comprising process shift determination device for determining whether to shift from the first process to the second process, on the basis of the organic substance concentration in the dissolution water.

6. The membrane cleaning device according to claim 5, wherein
the process shift determination device includes
an organic substance sensor to measure the organic substance concentration in the dissolution water in the ozone water generation tank in the first process,
a second memory to store a threshold for the organic substance concentration for shifting from the first process to the second process, and
a second processor to compare a measured value by the organic substance sensor with the threshold stored in the second memory, and to control the pH adjustment device so as to shift from the first process to the second process when the measured value becomes equal to or smaller than the threshold.

7. The membrane cleaning device according to claim 5, wherein
the process shift determination device includes
an organic substance sensor to measure an initial value of the organic substance concentration in the dissolution water in the ozone water generation tank,
an ozone gas sensor to measure an ozone gas amount supplied to the ozone water generation tank,
a third memory to store a threshold for an ozone gas amount needed until shifting from the first process to the second process, the threshold being set so as to correspond to the initial value of the organic substance concentration in the dissolution water, and
a third processor to acquire, from the third memory, the threshold corresponding to the initial value of the organic substance concentration measured by the organic substance sensor, to compare a measured value by the ozone gas sensor with the threshold, and to control the pH adjustment device so as to shift from the first process to the second process when the measured value becomes equal to or greater than the threshold.

8. The membrane cleaning device according to claim 5, wherein
the process shift determination device includes
a dissolved ozone sensor to measure the dissolved ozone concentration in the dissolution water in the ozone water generation tank in the first process,
an ozone gas sensor to measure an ozone gas amount supplied to the ozone water generation tank,
a fourth memory to store a threshold for the dissolved ozone concentration for shifting from the first process to the second process, the threshold being set so as to correspond to the ozone gas amount supplied to the ozone water generation tank, and
a fourth processor to acquire, from the fourth memory, the threshold corresponding to the ozone gas amount measured by the ozone gas sensor, to compare a measured value by the dissolved ozone sensor with the threshold, and to control the pH adjustment device so as to shift from the first process to the second process when the measured value becomes equal to or greater than the threshold, and
the fourth processor estimates the organic substance concentration in the dissolution water, using, as parameters, the dissolved ozone concentration in the dissolution water and the ozone gas amount supplied to the ozone water generation tank, and determines whether to shift from the first process to the second process, on the basis of the estimated organic substance concentration in the dissolution water.

9. The membrane cleaning device according to claim 4, wherein
the pH adjustment device includes
a pH sensor to measure pH of the dissolution water stored in the ozone water generation tank,
a pH adjuster to supply an acid or an alkali to the ozone water generation tank, to adjust pH of the dissolution water,
a fifth memory to store respective pH setting values of the dissolution water for the first process and the second process, and
a processor to control the pH adjuster so that pH of the dissolution water becomes the corresponding pH setting value stored in the fifth memory in each of the first process and the second process.

10. The membrane cleaning device according claim 1, wherein
the separation membrane is a separation membrane that makes separation into activated sludge and the treated water.

11. A membrane cleaning method for cleaning, with ozone water, a separation membrane for filtering treatment target water, the membrane cleaning method comprising:
an ozone water generation process of using treated water filtered through the separation membrane as dissolution water and dissolving ozone gas in the dissolution water, to generate ozone water, wherein
the ozone water generation process includes a first process of dissolving ozone gas in the dissolution water under a neutral or alkaline condition, and a second process of dissolving ozone gas in the dissolution water under an acidic condition after the first process, and
whether to shift from the first process to the second process is determined on the basis of an organic substance concentration in the dissolution water, and whether to start feeding the ozone water to the separation membrane is determined on the basis of a dissolved ozone concentration in the dissolution water.

12. The membrane cleaning device according to claim 2, wherein
the ozone water generation tank performs a first process of dissolving ozone gas in the dissolution water under a neutral or alkaline condition, and a second process of dissolving ozone gas in the dissolution water under an acidic condition after the first process.

13. The membrane cleaning device according to claim 12, further comprising a process shift determination device for determining whether to shift from the first process to the second process, on the basis of the organic substance concentration in the dissolution water.

14. The membrane cleaning device according to claim 13, wherein
the process shift determination device includes
an organic substance sensor to measure the organic substance concentration in the dissolution water in the ozone water generation tank in the first process,
a second memory to store a threshold for the organic substance concentration for shifting from the first process to the second process, and
a second processor to compare a measured value by the organic substance sensor with the threshold stored in the second memory, and to control the pH adjustment device so as to shift from the first process to the second process when the measured value becomes equal to or smaller than the threshold.

15. The membrane cleaning device according to claim 13, wherein
the process shift determination device includes
an organic substance sensor to measure an initial value of the organic substance concentration in the dissolution water in the ozone water generation tank,
an ozone gas sensor to measure an ozone gas amount supplied to the ozone water generation tank,
a third memory to store a threshold for an ozone gas amount needed until shifting from the first process to the second process, the threshold being set so as to correspond to the initial value of the organic substance concentration in the dissolution water, and
a third processor to acquire, from the third memory, the threshold corresponding to the initial value of the organic substance concentration measured by the organic substance sensor, to compare a measured value by the ozone gas sensor with the threshold, and to control the pH adjustment device so as to shift from the first process to the second process when the measured value becomes equal to or greater than the threshold.

16. The membrane cleaning device according to claim 13, wherein
the process shift determination device includes
a dissolved ozone sensor to measure the dissolved ozone concentration in the dissolution water in the ozone water generation tank in the first process,
an ozone gas sensor to measure an ozone gas amount supplied to the ozone water generation tank,
a fourth memory to store a threshold for the dissolved ozone concentration for shifting from the first process to the second process, the threshold being set so as to correspond to the ozone gas amount supplied to the ozone water generation tank, and
a fourth processor to acquire, from the fourth memory, the threshold corresponding to the ozone gas amount measured by the ozone gas sensor, to compare a measured value by the dissolved ozone sensor with the threshold, and to control the pH adjustment device so as to shift from the first process to the second process when the measured value becomes equal to or greater than the threshold, and
the fourth processor estimates the organic substance concentration in the dissolution water, using, as parameters, the dissolved ozone concentration in the dissolution water and the ozone gas amount supplied to the ozone water generation tank, and determines whether to shift from the first process to the second process, on the basis of the estimated organic substance concentration in the dissolution water.

17. The membrane cleaning device according to claim 12, wherein
the pH adjustment device includes
a pH sensor to measure pH of the dissolution water stored in the ozone water generation tank,
a pH adjuster to supply an acid or an alkali to the ozone water generation tank, to adjust pH of the dissolution water,
a fifth memory to store respective pH setting values of the dissolution water for the first process and the second process, and
a processor to control the pH adjuster so that pH of the dissolution water becomes the corresponding pH setting value stored in the fifth memory in each of the first process and the second process.

18. The membrane cleaning device according to claim 5, wherein
the pH adjustment device includes
a pH sensor to measure pH of the dissolution
water stored in the ozone water generation tank,
a pH adjuster to supply an acid or an alkali to the ozone water generation tank, to adjust pH of the dissolution water,
a fifth memory to store respective pH setting values of the dissolution water for the first process and the second process, and
a processor to control the pH adjuster so that pH of the dissolution water becomes the corresponding pH setting value stored in the fifth memory in each of the first process and the second process.
